(19) United States
(12) Patent Application Publication
(10) Pub. No.: US 2022/0303091 A1
(43) Pub. Date: Sep. 22, 2022

(54) CHANNEL BASED BEAMFORMING

(71) Applicant: Apple Inc., Cupertino, CA (US)

(72) Inventors: Yushu Zhang, Beijing (CN); Dawei Zhang, Saratoga, CA (US); Haitong Sun, Cupertino, CA (US); Rohit U. Nabar, Sunnyvale, CA (US); Wei Zeng, Saratoga, CA (US); Weidong Yang, San Diego, CA (US); Yakun Sun, San Jose, CA (US)

(73) Assignee: Apple Inc., Cupertino, CA (US)

(21) Appl. No.: 17/598,225

(22) PCT Filed: Jun. 15, 2021
(86) PCT No.: PCT/US2021/037404

§ 371 Date: Sep. 24, 2021

(30) Foreign Application Priority Data
Aug. 5, 2020 (CN) PCT/CN2020/107180

(51) Int. Cl. H04L 5/00; H04W 72/04

(52) U.S. Cl. CPC H04L 5/0048; H04L 5/0007; H04W 72/046

(57) ABSTRACT

The present application relates to devices and components including apparatus, systems, and methods to provide channel-based beamforming in wireless communication systems.

### CROSS REFERENCE TO RELATED APPLICATIONS

This application claims the benefit of International Application No. PCT/CN2020/107180, filed Aug. 5, 2020, which is hereby incorporated by reference in its entirety for all purposes.

### BACKGROUND

A user equipment (UE) may use analog beamforming to receive communications from other network components. Analog beamforming may improve coverage.

### BRIEF DESCRIPTION OF THE DRAWINGS

FIG. 1 illustrates a network environment in accordance with some embodiments.

FIG. 2 illustrates a channel-based beamforming operation in accordance with some embodiments.

FIG. 3 illustrates a downlink resource grid in accordance with some embodiments.

FIG. 4 illustrates a downlink resource grid in accordance with some embodiments.

FIG. 5 illustrates a downlink resource grid in accordance with some embodiments.

FIG. 6 illustrates downlink resources in accordance with some embodiments.

FIG. 7 illustrates an operational flow/algorithmic structure in accordance some embodiments.

FIG. 8 illustrates an operational flow/algorithmic structure in accordance with some embodiments.

FIG. 9 illustrates an operational flow/algorithmic structure in accordance with some embodiments.

FIG. 10 illustrates receive components in accordance with some embodiments.

FIG. 11 illustrates a user equipment in accordance with some embodiments.

FIG. 12 illustrates a gNB in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PHD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usages, electrical power, input/output operations, ports or network sockets, channel/link allocations, throughput, memory usage, storage, networks, databases and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

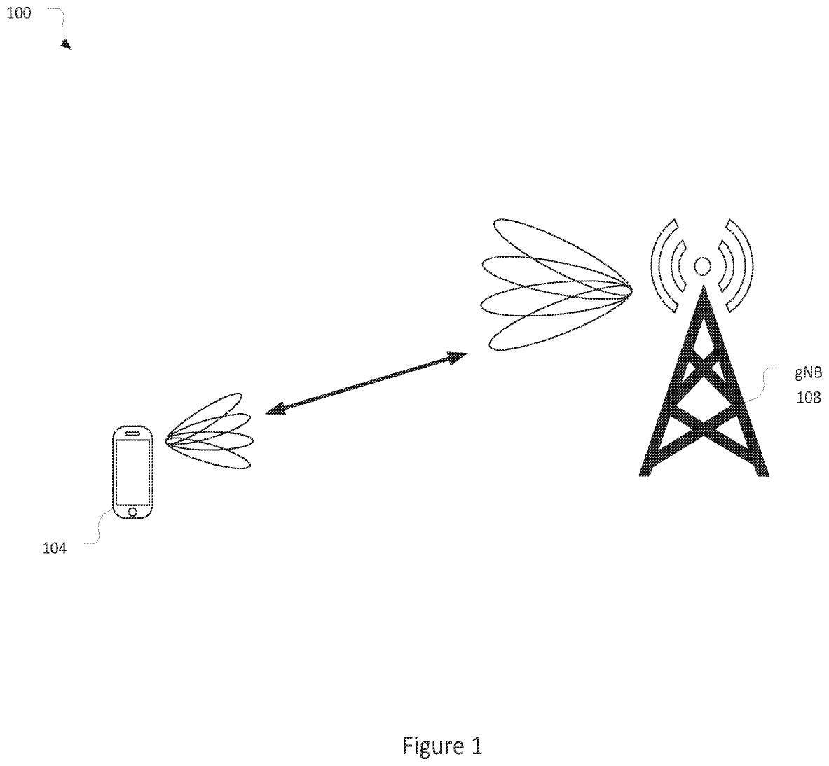

FIG. 1 illustrates a network environment 100 in accordance with some embodiments. The network environment 100 may include a UE 104 and a gNB 108. The gNB 108 may be a base station that provides a wireless access cell, for example, a 3GPP New Radio (NR) cell, through which the UE 104 may communicate with the gNB 108. The UE 104 and the gNB 108 may communicate over an air interface compatible with 3GPP technical specifications such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and PITY layers and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel state information-reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, 12 resource elements. A control channel element (CCE) may represent a group of resources used to transmit PDCCH. One CCE may be mapped to a number of REGs, for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread are shared. In QCL Type C, antenna ports share Doppler shift and average delay. In QCL Type D, antenna ports share spatial receiver parameters.

The gNB 108 may provide transmission configuration indicator (TCI) state information to the UE 104 to indicate QCL relationships between antenna ports used for reference signals (for example, synchronization signal/PBCH or CSI-RS) and downlink data or control signaling, for example, PDSCH or PDCCH. The gNB 108 may use a combination of RRC signaling, MAC control element signaling, and DCI, to inform the UE 104 of these QCL, relationships.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

The UE 104 may select a beam to receive downlink transmissions based on SSBs and CSI-RSs. The UE 104, while in a radio resource control (RRC)-idle mode, may perform an initial acquisition during a random-access procedure using SSBs and physical random access channel (PRACH) preambles to establish uplink and downlink beam pairs. These initial beam pairs may correspond to relatively wide beams. The UE 104 may then enter an RRC-connected mode and initiate beam refinement procedures to select beams that are more directional and have higher gain. The beam refinement procedures may be based on CSI-RS.

In various embodiments, both digital and analog beamforming concepts may be performed by the UE 104 and the gNB 108. However, digital beamforming may utilize more radio-frequency chains, which may lead to increased power consumption. Therefore, in some embodiments, the UE 104 may rely primarily on analog beamforming, which may improve coverage and provide a desirable link budget, especially when a good gNB/UE beam pair is used.

In some embodiments, the UE 104 may use channel-based beamforming to determine a desired beam for receiving downlink communications.

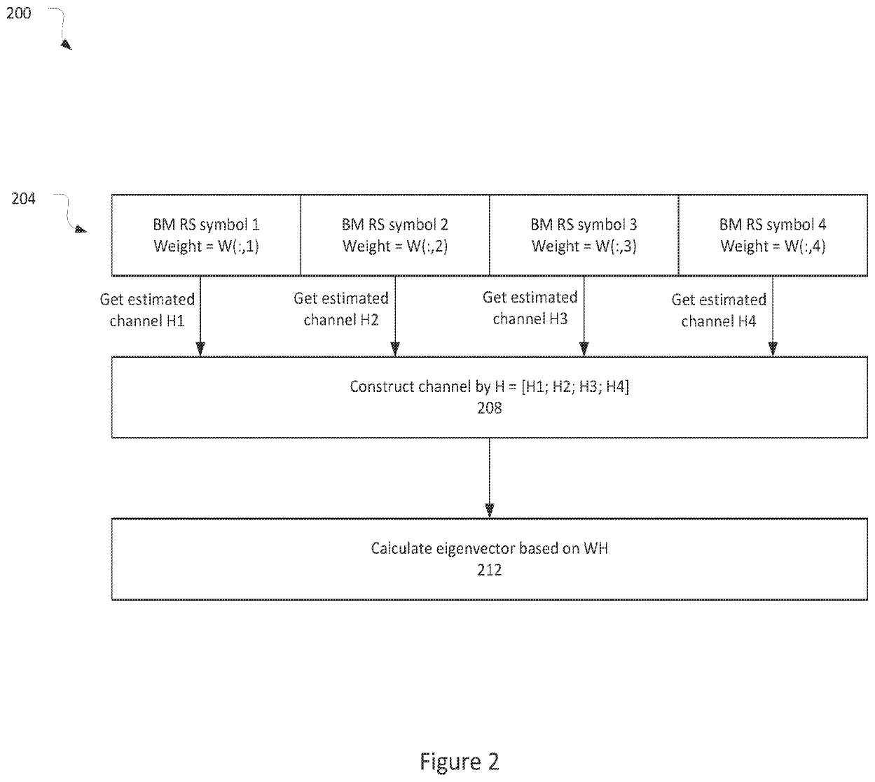

If the UE 104 includes N antenna elements with one port, the UE 104 can get an analog beam based on N measurement instances. FIG. 2 illustrates a channel-based beamforming operation 200 using four antenna elements with one port in accordance with some embodiments.

At 204, the operation 200 may include applying different sequences from a predefined matrix (which may be stored in memory of the UE) as the weight to receive different symbols of beam management (BM) reference signal (RS) and get estimated channels. The BM RS may correspond to an SSB or CSI-RS. The predefined matrix may be, for example, a normalized Hadamard matrix as follows:

$$W = [ \begin{matrix}0.5 & 0.5 & 0.5 & 0.5 \\ 0.5 & - 0.5 & 0.5 & - 0.5 \\ 0.5 & 0.5 & - 0.5 & 0.5 \\ 0.5 & - 0.5 & - 0.5 & - 0.5\end{matrix} ] .$$

A first weight, W(:,1) may be provided to a BM RS received on a first symbol (BM RS symbol 1); a second weight W(:,2) may be provided to a BM RS received on a second symbol (BM RS symbol 2); a third weight W(:,3) may be provided to a BM RS received on a third symbol (BM RS symbol 3); and a fourth weight W (:,4) may be provided to a BM RS received on a fourth symbol (BM RS symbol 4). In this manner, N instances of the channels (H1-H4) may be obtained.

At 208, the operation may include constructing the combined channel from the N instances of the channel obtained at 204. The combined channel may be given by H=[H1; H2; H3; H4].

At 212, the operation may include calculating an eigenvector based on the combined channel and predefined matrix. In some embodiments, the eigenyector may be obtained by multiplying the predefined matrix W by the combined channel The UE 104 may use the eigenvector for the beamforming weights to provide the analog beam for receiving downlink communications from the gNB 108.

A number of operational considerations may be applied to facilitate channel-based beamforming. For example, the same precoder/beam may be applied for the BM RS transmitted over a number of symbols that is no less than a number of antenna elements divided by number of ports; and the symbols for the BM RS should be transmitted within a time period to maintain coherency.

In various embodiments, aspects are described to define control signaling to support channel-based beamforming. The control signaling may include: signaling to maintain a common understanding between the gNB 108 and the UE 104 of a minimal number of symbols per BM RS resource or minimal number of resources; signaling to configure whether the same precoder/beam is applied for different BM RS symbols; and signaling for a maximal time period for the BM RS symbols. In some embodiments, the minimal number or maximal time period may correspond to desired number or time periods. For example, the minimal number of symbols may be a number of symbols in which the UE 104 desires to form a basis for channel-based beamforming. In some embodiments, channel-based beamforming may be performed even if the number of symbols is less than the desired minimal number of symbols.

In general, there may be three options to facilitate channel-based beamforming. In various embodiments aspects from each of these options may be used together. Therefore, these options are not to be considered mutually exclusive.

In a first option, the gNB 108 may configure more than one symbol per CSI-RS resource for beam management. The UE 104 may then apply channel-based beamforming per CSI-RS resource.

For each CSI-RS resource, the number of symbols may be configured. In some embodiments, the configuration may be provided by adding an appropriate field in a CSI-RS resource mapping (CSI-RS-ResourceMapping) information element that is used to configure a resource element mapping of a CSI-RS in time and frequency domain. In some embodiments, the CSI-RS-ResourceMapping IE may be configured as follows.

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)), |

},

| | |
|---|---|
| nrofPorts | ENUMERATED {p1, p2, p4, p12, p16, p24, p32}, |
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD-2, cdm8-FD2-TD4}, |

density CHOICE {

| | |
|---|---|
| dot5 | ENUMERATED {evenPRBs, oddPRBs}, |
| one | NULL, |
| three | NULL, |
| spare | NULL |

},
freqBandCSI-FrequencyOccupation,

| | |
|---|---|
| nrofSymbols | INTEGER (1..14), |

...
}.

The frequency domain allocation (frequencyDomainAllocation) field may provide the frequency allocation within a physical resource block as provided in, for example, 3GPP Technical Specification (TS) 38.211 v16.2.0 (2020-07-14) Section 7.4.1.5.3.

The number of ports (nrofPorts) field may provide an enumerated number of antenna ports that may be used for the CSI-RS resource.

The first OFDM symbol in time domain (firstOFDMSymbolinTimeDomain) field may provide a time domain allocation by indicating a first OFDM symbol within a PRB used for the CSI-RS. The first OFDM symbol in time domain 2 (firstOFDMSymbolinTimeDomain2) may be used when a DMRS TypeA position three is used.

The code division multiplexing (CDM) type (cdm-Type) field may define CDM values and patterns.

The density field may define CSI-RS frequency density of each CSI-RS port per PRB, and CSI-RS PRB offset in case of the density value of ½. For density ½, the odd/even PRB allocation may be with respect to a common resource block.

The frequency band (freqBand) field may indicate whether the CSI-RS is wideband or partial band.

The number of symbols (nrofSymbols) field may indicate the number of OFDM symbols configured for each CSI-RS resource. The configuration of more than one symbol my facilitate channel-based beamforming as described herein. In some embodiments, this field may only be applicable for some types of CSI-RSs. For example, this field may be applicable for CSI-RS for RSRP/SINR computation or CSI-RS for mobility and may not be applicable for other CSI-RS types.

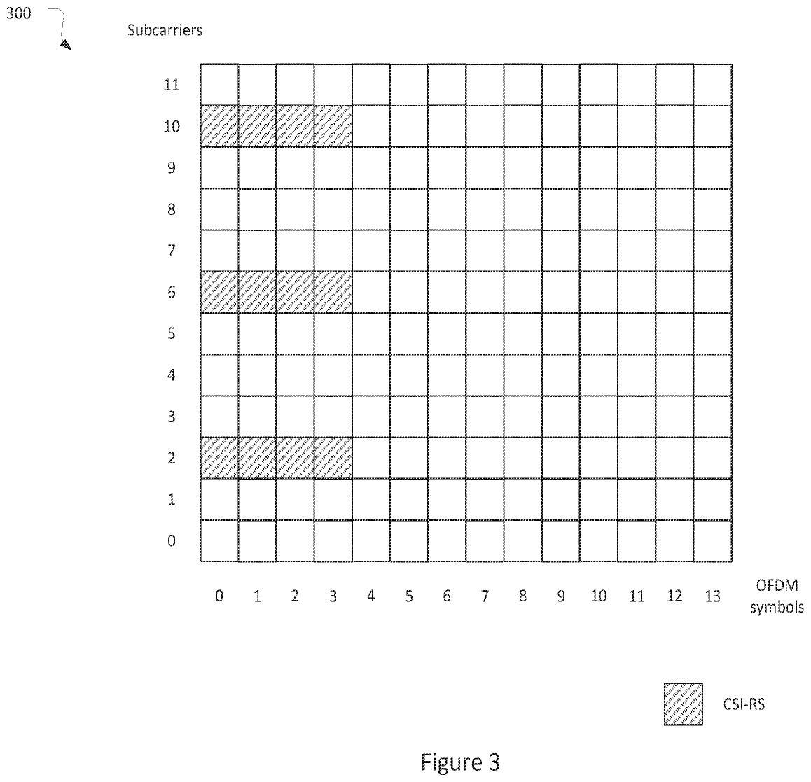

If more than one symbol is configured in option 1, the mapping of the CSI-RS to resource elements of the various symbols may be done in a number of ways. FIGS. 3-5 illustrate RE mapping patterns in accordance with some embodiments.

FIG. 3 illustrates a downlink resource grid 300 with a first RE mapping pattern in accordance with some embodiments. The downlink resource grid 300 may include 14 OFDM symbols in a time domain, and 12 subcarriers in a frequency domain.

In this embodiment, the CSI-RS may be mapped to three resource elements in each OFDM symbol. Four consecutive OFDM symbols are configured for the CSI-RS resource, starting with OFDM symbol 0. In this embodiment, the RE mapping pattern may be the same for each OFDM symbol. For example, the CSI-RS may be mapped to REs 2, 6, and 10 in each of OFDM symbols 0, 1, 2, and 3.

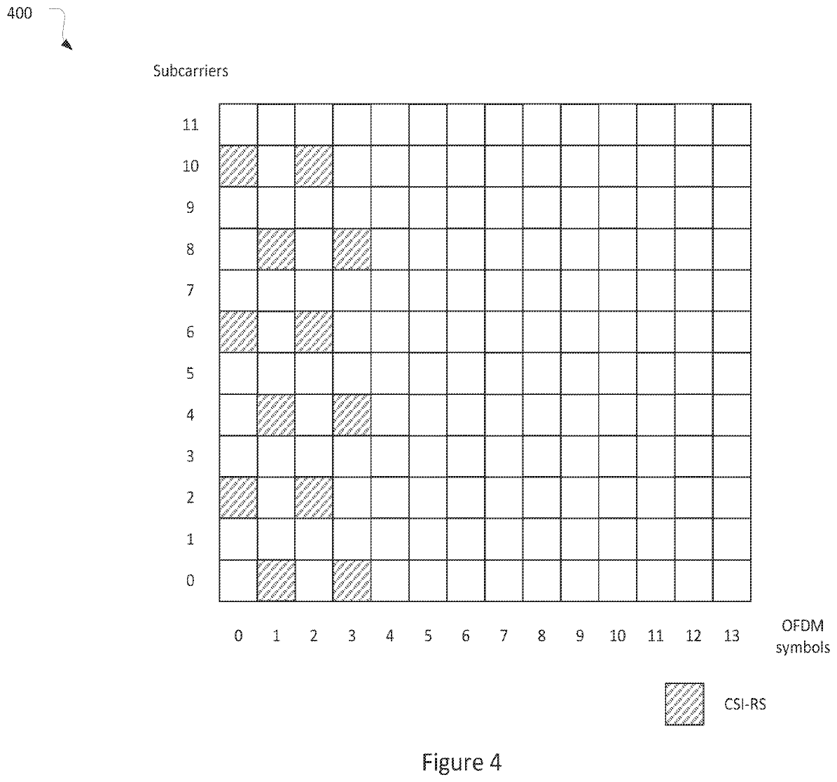

FIG. 4 illustrates a downlink resource grid 400 with a second RE mapping pattern in accordance with some embodiments. The downlink resource grid 400 may include 14 OFDM symbols in a time domain and 12 subcarriers in a frequency domain.

In this embodiment, the CSI-RS may be mapped to four consecutive OFDM symbols, starting with OFDM symbol 0 similar to shown above with respect to FIG. 3. However, in this embodiment the resource elements used in the different symbols may be different. For example, in OFDM symbol 0, resource elements 2, 6, and 10 may be used to carry the CSI-RS. For OFDM symbol 1, the mapping pattern may be shifted by two resource elements. Therefore, the CSI-RS may be carried by resource elements 4, 8, and 0 in OFDM symbol 1. The mapping pattern may be shifted again by two resource elements such that resource elements 2, 6, and 10 carried the CSI-RS in OFDM symbol 2. Mapping pattern may be shifted again by two resource element such that resource elements 0, 4, and 8 carried the CSI-RS in OFDM symbol 3. The offset shift between consecutive OFDM symbols that carry the CSI-RS may be predefined or configured by higher-layer signaling such as, for example, RRC signaling.

While FIG. 4 illustrates the RE mapping pattern being shifted for each OFDM symbol, in other embodiments, other RE mapping patterns or densities may be used. For example, a different number of resource elements may be used to carry the CSI-RS in different OFDM symbols.

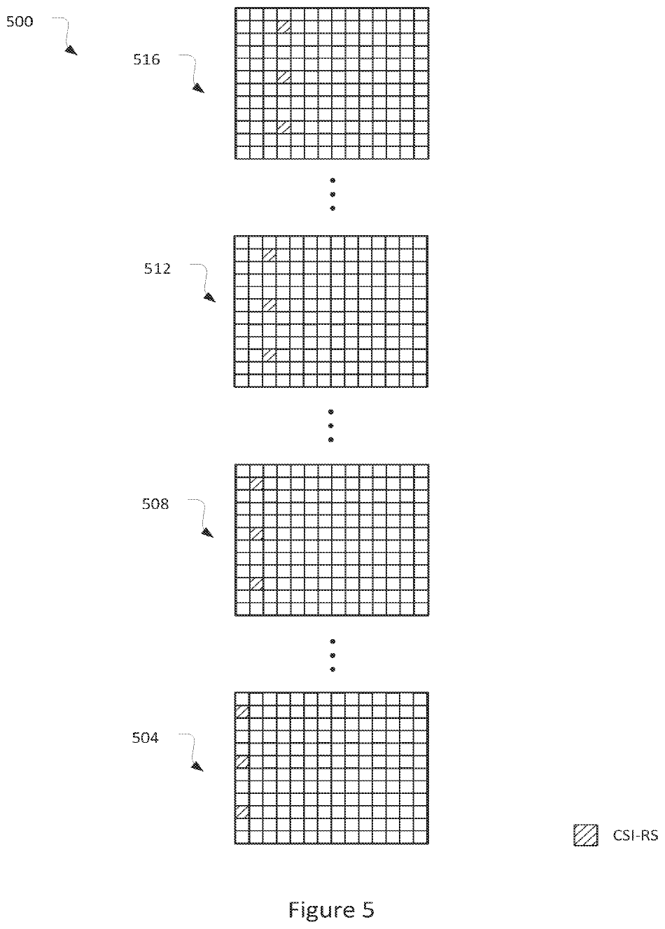

FIG. 5 illustrates downlink resource grid 500 with a third RE mapping option in accordance with some embodiments. The downlink resource grid 500 may include a first PRB 504, a second PRB 508, a third PRB 512, and a fourth PRB 516.

In this embodiment, different bandwidths may be used for the CSI-RS in different symbols. For example, the first PRB 504 may include CSI-RS in a first OFDM symbol. The second PRB 508 may include the CSI-RS in a second symbol. The third PRB 512 may include the CSI-RS and a third symbol. And the fourth PRB 516 may include the CSI-RS in a fourth symbol. Thus, the CSI-RS has a frequency bandwidth offset of one or more PRBs from OFDM symbol to OFDM symbol. In various embodiments, the frequency bandwidth offset may be predefined or configured by higher-layer signaling such as, for example, RRC signaling.

While the embodiments shown in FIGS. 3-5 illustrates consecutive OFDM symbols being used to carry the CSI-RS, other embodiments may include non-consecutive OFDM symbols.

In some embodiments, the UE 104 may report a desired minimal number of CSI-RS symbols per CSI-RS resource by UE capability. Then, to facilitate the channel-based beamforming for CSI-RS for BM, the gNB 108 can configure the CSI-RS with no less than the desired minimal number of CSI-RS symbols reported. In some embodiments, the gNB 108 may configure the CSI-RS with more than the desired minimal number of CSI-RS symbols.

In various embodiments, the gNB 108 may configure the UE 104 with one or more CSI-RS resource sets. Each resource set may include one or more CSI-RS resources. A single resource set may be configured with a sequence of up to 64 CSI-RS resource identities. The resource set configuration may include a flag to indicate whether repetition is enabled. If the gNB 108 sets the repetition flag to ‘ON,’ then all the CSI-RSs belonging to the resource set may be transmitted using the same beam, for example, they may be transmitted using the same spatial domain filter.

In some embodiments, the gNB 108 may use the repetition flag during beam management procedures to change a beam selection, for example for the purposes of beam refinement, which may be referred to as a P-2 BM procedure, or to improve a downlink UE receive beam, which may be referred to as a P-3 BM procedure.

For the P-3 BM procedure, the gNB 108 may transmit repetitions of the CSI-RS using a beam selected during the P-2 BM procedure. This may provide the UE 104 with sufficient time to switch between its own beam positions and identify the best beam to pair with the beam selected by the gNB 108.

In some embodiments, when the gNB 108 receives an indication from the UE 104 with a desired minimal number of CSI-RS symbols for channel-based beamforming, the gNB 108 may ensure that, for a CSI-RS in a resource set with repetition set to “ON,” the total number of symbols may not be less than the minimal number of CSI-RS symbols reported.

In a second option, the gNB 108 may configure a new QCL type or port association for CSI-RS resources, The new QCL type or port association may indicate that reference signals that are QCLd or port associated are transmitted from the same precoder and analog beam. This may allow the UE 104 to apply channel-based beamforming based on a CSI-RS for BM along with other reference signals that are QCLd or port associated with the CSI-RS as described as follows.

The new QCL type may be referred to as QCL Type E for purposes of the present description; however, the labeling of the QCL type is not limiting. QCL Type E may indicate that signals transmitted by antenna ports share the following parameters: Doppler shift, Doppler spread, average delay, delay spread, spatial receive parameter, and average gain. The QCL source may be CSI-RS or SSB.

Thus, in some embodiments, the gNB 108 may indicate that another reference signal has a QCL Type E relationship with a CSI-RS for BM. The other reference signal, which may be the QCL source, may be a CSI-RS or SSB. The UE 104 may then apply channel-based beamforming based on receipt of the CSI-RS and the QCL source.

Consider that the UE 104 has four antenna elements associated with one antenna port and, therefore, needs four measurements to support channel-based beamforming. The UE 104 may make two measurements based on a CSI RS for BM and another two measurements based on a QCL source (for example, another CSI-RS or SSB) that has the QCL Type E relationship with e CSI-RS for BM.

In another embodiment, the gNB 108 may indicate a port association between a first antenna port that is used for CSI-RS for BM and a second antenna port that is used for another CSI-RS SSB. Similar to the QCL: type relationship described above, the UE 104 may assume that reference signals transmitted on port-associated antenna ports may be transmitted from the same precoder and analog beam. Thus, the UE 104 may base measurements for channel-based beamforming on reference signals transmitted on either of the port associated antenna ports.

In some embodiments, the UE 104 may report a desired minimal number of symbols for CSI-RS resources for UE beam searching to the gNB 108. If the CSI-RS for BM is QCLd or port associated with an SSB, the SSB could be considered as three or four CSI-RS resources. Whether the SSB is to be considered as three or four CSI-RS may be predefined or reported by UE capability.

In some embodiments, the relationship between resources used for channel-based beamforming calculations may only apply for a limited period of time. Thus, in some embodiments, a time window may be used to restrict the resources used for channel-based beamforming.

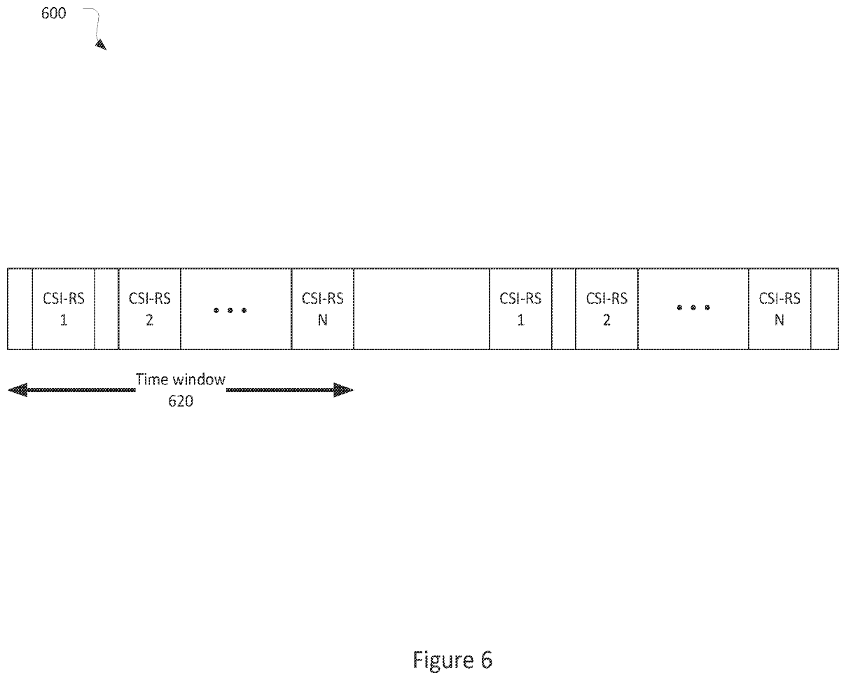

FIG. 6 illustrates downlink resources 600 in accordance with some embodiments. The downlink resources 600 may include a N CSI-RS resources configured for the UE 104, which includes N antenna elements coupled to one antenna port, to perform channel-based beamforming. The N CSI-RS resources may include CSI-RS for BM along with one or more reference signals that are QCLd or port associated with the CSI-RS for BM.

If the burst of N CSI-RS resources occur within a time window 604, the UE 104 may assume the phase for the resources is coherent and, therefore, may use measurements from these N CSI-RS to construct the whole channel for the channel-based beamforming. In some embodiments, the UE 104 may report a desired maximum time window (for example, time window 620) for the CSI-RS resources for UE beam searching to the gNB 108.

In some embodiments, the channel-based measurements may be based on SSBs transmitted in one or more serving cells. For example, in some embodiments, the gNB 108 may configure a QCL relationship (for example, QCL Type E) or port association between SSBs in a serving cell or across serving cells. The UE 104 may then apply channel-based beamforming for the SSBs QCLd or port associated.

The QCL relationship or port association between SSBs may be similar to that described above with respect to CSI-RS resources. Similarly, the UE 104 may assume that QCLd or port-associated SSBs, in a same serving cell or different serving cells, are transmitted from the same precoder and analog beam. Thus, the channel-based measurements may be taken on a plurality of QCLd or port-associated SSBs.

In some embodiments, a QCL or port-association relationship between SSBs may be established by configuring one or more SSB sets. Each SSB set may include SSBs that may be in a plurality of component carriers of a band or band group. The UE 104 may determine that SSBs in a same SSB set are QCLd or port associated with one another for purposes of channel-based beamforming measurements.

The QCL and port association relationships described herein may facilitate beam failure detection (BFD) and radio link monitoring (RLM) operations.

RLM operations may be performed by various layers of the UE 104. For example, a physical layer may generate out-of-sync indications if RLM-reference signals (RLM-RSs) fall below a first quality level (Qout) which the radio link is considered unreliable, which may be based on a first block error level rate (BLER) target of a hypothetical PDCCH transmission; generate an in-sync indication if at least one RLM-RS exceeds a second quality level (Qin) at which the radio link is considered reliable, which may be based on a second BLER target of the hypothetical PDCCH transmission; and generate a beam failure instance if all RLM-RSs fall below a third quality level (Qout_LR), which may correspond to a BLER of 10% for the hypothetical PDCCH transmission. The out-of-sync and in-sync indications may be provided to an RRC layer and the beam failure instances may be provided to a MAC layer.

The RRC layer may evaluate conditions for radio link failure and may trigger radio link failure and RRC reestablishment. The MAC layer may evaluate conditions for beam failure and trigger beam failure and beam failure recovery.

In some embodiments, the gNB 108 may configure QCLd or port associated CSI-RS resources or SSBs as RLM-RSs for BFD/RLM operations. The CSI-RS resources or SSB resources that are QCLd or port associated may be counted as one RLM-RS when reporting the UE capability for BFD and RLM.

In some embodiments, the hypothetical BLERs, which provide the basis for each beam failure instance or in-sync/out-of-sync indication, may be based on the beamforming weight calculated from the channel-based beamforming operations as described herein.

Once beam failure has been detected, the UE 104 may attempt to recover by initiating a random-access procedure. Before transmitting a PRACH preamble, the UE 104 may identify a new target beam. A candidate beam reference signal list configuration may provide up to 16 SSB or CSI-RS beams as candidate beams. Each beam may be allocated a specific dedicated PRACH preamble so the gNB 108 can use the preamble transmission to deduce which beam has been selected by the UE 104. In some embodiments, the gNB 108 may configure multiple CSI-RS resources QCLd or port associated for candidate beam detection (CBD). For a primary cell (Pcell) beam failure recovery, each PRACH resource may then be associated with more CSI-RS resources. For a secondary cell (Scell) beam failure recovery, the CSI-RS resources can be divided into N sets, where the CSI-RS resources in a set are QCLd or port associated with one another. The UE 104 may then report the set index by a beam failure recovery MAC CE.

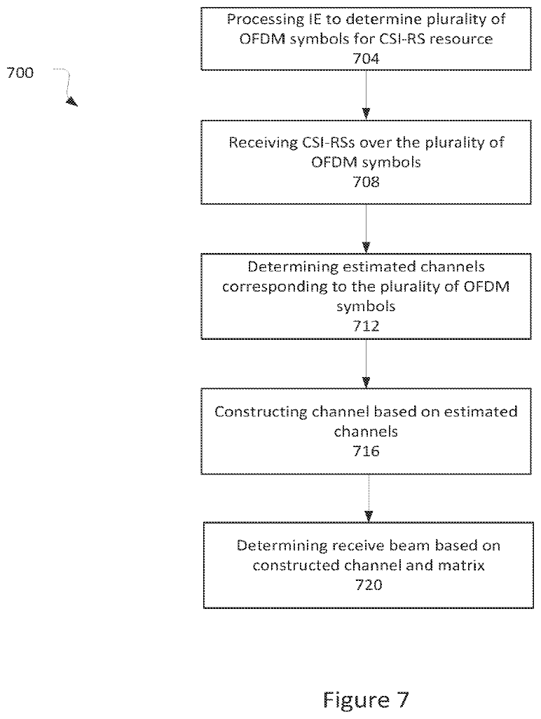

FIG. 7 may include an operation flow/algorithmic structure 700 in accordance with some embodiments. The operation flow/algorithmic structure 700 may be performed or implemented by a UE such as, for example, UE 104 or 1100; or components thereof, for example, baseband processor 1104A.

The operation flow/algorithmic structure 700 may include, at 704, processing an IE to determine the plurality of OFDM symbols for a CSI-RS resource. The IE may be a CSI-RS resource mapping IE that includes a number of symbols field. The number of symbols field may include a value that corresponds to the plurality of OFDM symbols for the CSI-RS resource.

In some embodiments, the number of OFDM symbols indicated in the IE may be based on a UE capability report, The UE capability report may have provided a gNB with information about a number of measurement instances desired by the UE for a channel-based beamforming operation. The number of measurement instances may correspond to a number of antenna elements divided by a number of antenna ports of the UE.

In some embodiments, the IE may provide other information to facilitate a determination of which resource elements in a particular OFDM symbol are to include a CSI-RS.

The operation flow/algorithmic structure 700 may further include, at 708, receiving CSI-RSs over the plurality of OFDM symbols. In some embodiments, the CSI-RS may be received on the same resource elements in each of the plurality of OFDM symbols. In other embodiments, a resource element mapping pattern may be shifted in subsequent OFDM symbols. In yet other embodiments, different resource element mapping patterns may be used, different numbers of resource elements may be used, and different bandwidths may be used for transmitting/receiving the CSI-RSs in the plurality of OFDM symbols.

The operation flow/algorithmic structure 700 may further include, at 712, determining estimated channels corresponding to the plurality of OFDM symbols. In some embodiments, different weights may be applied to receive the CSI-RSs on different OFDM symbols in order to obtain the channel estimates. The weights may correspond to sequences from a predefined matrix such as, for example, a normalized Hadamard matrix.

The operation flow/algorithmic structure 700 may further include, at 716, constructing a channel based on the estimated channels. The channel may be constructed by utilizing each of the channel estimates from receiving the CSI-RSs over the plurality of OFDM symbols.

The operation flow/algorithmic structure 700 may further include, at 720, determining a receive beam based on the constructed channel and a matrix. In some embodiments, an eigenvector may be calculated based on the constructed channel and the predefined matrix. The eigenvector may correspond to the analog receive beam.

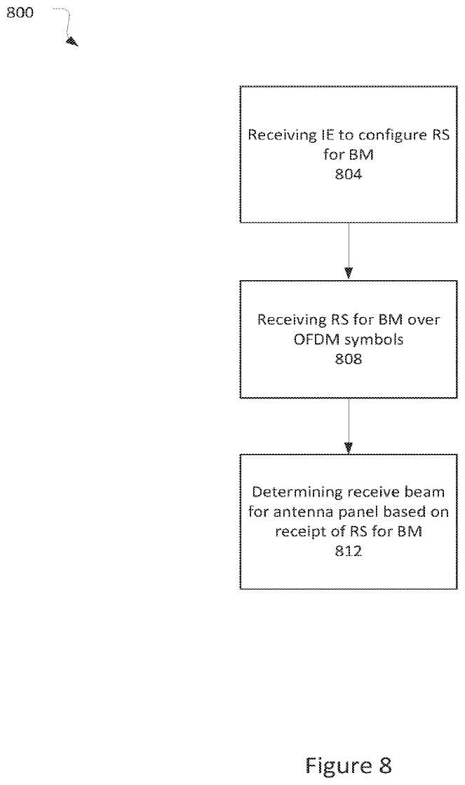

FIG. 8 may include an operation flow/algorithmic structure 800 in accordance with some embodiments. The operation flow/algorithmic structure 800 may be performed or implemented by a UE such as, for example, UE 104 or 1100; or components thereof, for example, baseband processor 1104A.

The operation flow/algorithmic structure 800 may include, at 804, receiving an IE to configure an RS for BM. The IE may include an indication that the RS for BM is beam associated with another signal, which may be a CSI-RS or SSB. The RS for BM may, itself, be a CSI-RS car SSB. In various embodiments, the beam association may be an indication that a port over which the RS for BM is to be transmitted is QCLd (for example, QCL Type E) with a port over which the other signal is transmitted. In other embodiments, the beam association may be an indication that there is a port association between the two ports. In either case, the UE may assume that the RS for BM and the other signal are both transmitted from the same antenna port, for example, transmitted with the same precoder and analog beam.

In some embodiments, the indication may be a TCI state that indicates a QCL relationship between the RS for BM and the other signal.

In embodiments in which the other signal is an SSB, the UE may determine that the SSB corresponds to three or four CSI-RS transmissions for purposes of the channel-based beamforming operation. This may be based on a predefined configuration or UE capability.

The operation flow/algorithmic structure 800 may further include, at 808, receiving the RS for BM and beam-associated signal over a plurality of OFDM symbols. In various embodiments, the plurality of OFDM symbols over which the RS for BM and beam-associated signal are received may correspond to a number of measurement instances desired by the UE for a channel-based beamforming operation.

The operation flow/algorithmic structure 800 may further include, at 812, determining a receive beam for an antenna panel based on receipt of the RS for BM and the beam-associated signal. In some embodiments, the receive beam may be determined based on a predefined matrix and channel estimates/calculations as described herein.

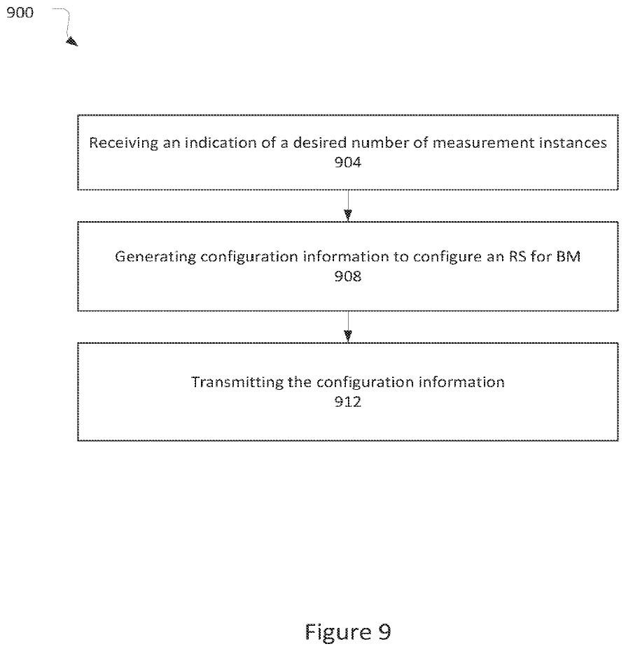

FIG. 9 may include an operation flow/algorithmic structure 900 in accordance with some embodiments. In some embodiments, the operation flow/algorithmic structure 900 may be performed or implemented by a gNB, for example, gNB 108 or 1200; or components thereof, for example, baseband processor 1204A.

The operation flow/algorithmic structure 900 may include, at 904, receiving an indication of a number of measurement instances desired for a channel-based beamforming operation at a UE. In some embodiments, the indication may be received in a UE capability report. The number of measurement instances may correspond to a number of antenna elements divided by a number of antenna ports at the UE.

The operation flow/algorithmic structure 900 array further include, at 908, generating configuration information to configure an RS for BM. The RS may be a CSI-RS or an SSB.

In some embodiments, a CSI-RS resource may be configured with a number of OFDM symbols that equal to or greater than the number of measurement instances desired by the UE.

In some embodiments, the configuration information may additionally/alternatively include beam association information to associate a beam used to transmit an RS for BM with another signal, for example, a CSI-RS or SSB. The gNB may transmit the RS for BM and the other signal over a plurality of OFDM symbols that is at least equal to the number of measurement instances.

The operation flow/algorithmic structure 900 may further include, at 912, transmitting the configuration information to the UE. In some embodiments, the configuration information may be transmitted to the UE in one or more configuration signals.

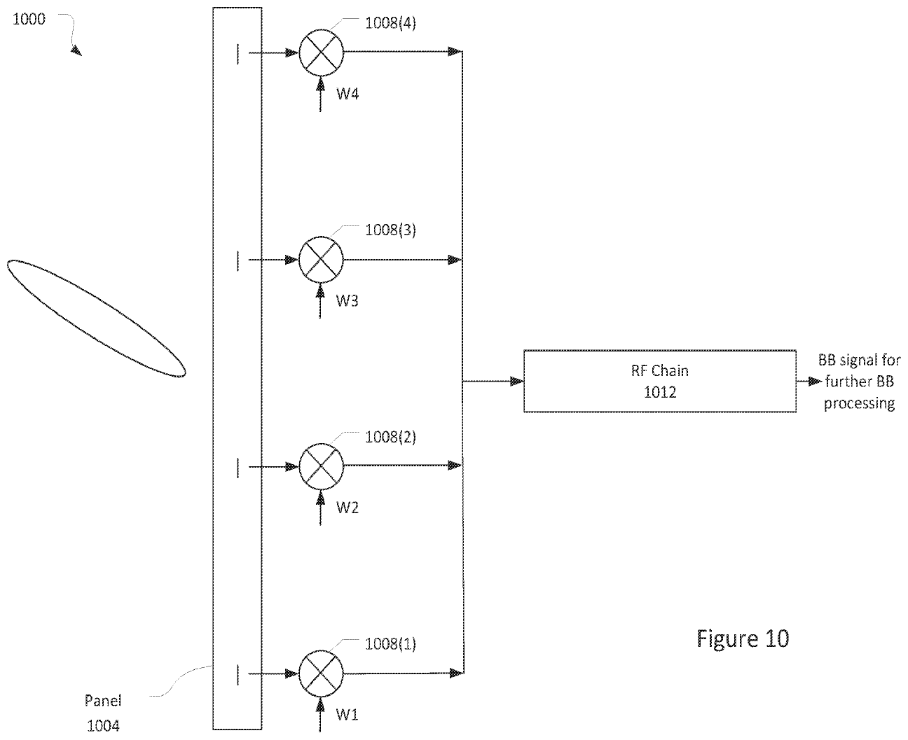

FIG. 10 illustrates receive components 1000 of the UE 104 in accordance with some embodiments. The receive components 1000 may include an antenna panel 1004 that includes a number of antenna elements. The panel 1004 is shown with four antenna elements, but other embodiments may include other numbers.

The antenna panel 1004 may be coupled to analog beamforming (BF) components that include a number of phase shifters 1008(1)-1008(4). The phase shifters 1008(1)-1008(4) may be coupled with a radio-frequency (RF) chain 1012. The RF chain 1012 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1008(1)-1008(4) to provide a receive beam at the antenna panel 1004. These BF weights may be determined based on the channel-based beamforming described herein. For example, the BF weights may be based on an eigenvector determined described with respect to the operation of FIG. 2.

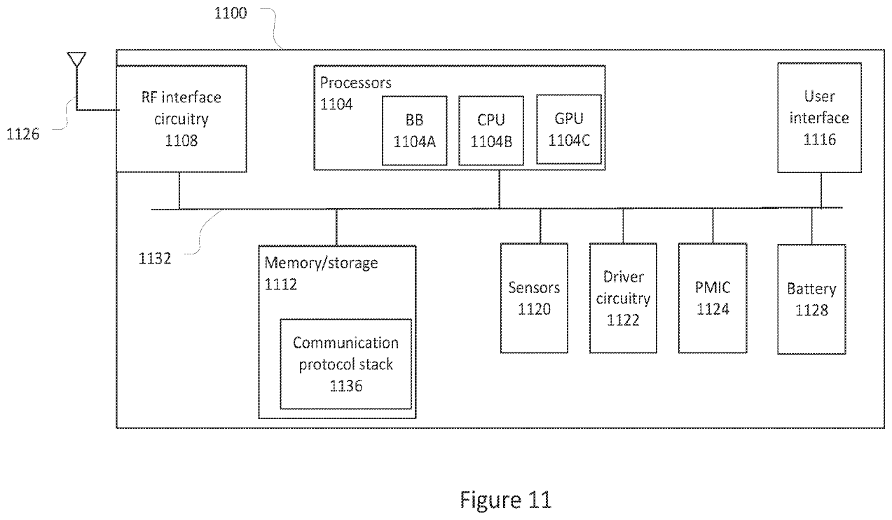

FIG. 11 illustrates a UE 1100 in accordance with some embodiments. The UE 1100 may be similar to and substantially interchangeable with UE 104 of FIG. 1.

Similar to that described above with respect to UE 104, the UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.) video surveillance/monitoring devices (for example, cameras, video cameras, etc.) wearable devices; relaxed-IoT devices. In some embodiments, the UE may be a reduced capacity UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program codes, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The baseband processor circuitry 1104A may also access group information 1124 from memory/storage 1112 to determine search space groups in which a number of repetitions of a PDCCH may be transmitted.

The memory/storage 1112 may include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random-access memory (DRAM), static random-access memory (SRAM), erasable programmable read-only memory (EPROM), electrically erasable programmable read only memory (EEPROM), Flash memory, solid-state memory, or any other type of memory device technology.

The RF interface circuitry 1108 may include transceiver circuitry and radio frequency front module (RFEM) that allows the LIE 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include a number of antenna elements that each convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, phased array antennas, etc. The antenna. 1126 may have one or more panels designed for specific frequency bands including bands in FR1 or FR2.

The user interface circuitry 1116 includes various input/output (I/O) devices designed to enable user interaction with the LIE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphone, scanner, headset, or the like. The output device circuitry includes any physical or virtual means for showing information or otherwise conveying, information, such as sensor readings, actuator position(s), or other like information. Output device circuitry may include any number or combinations of audio or visual display, including, inter alia, one or more simple visual outputs/indicators (for example, binary status indicators such as light emitting diodes LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like), depth sensors, ambient light sensors, ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state, where it disconnects from the network and does not perform operations such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC_Connected state. An additional power saving mode may allow a device to be unavailable to the network for periods longer than a paging interval (ranging from seconds to a few hours). During this tune, the device is totally unreachable to the network and may power down completely. Any data sent during this time incurs a large delay and it is assumed the delay is acceptable.

A battery 1128 may power the UE 1100, although in some examples the UE 1100 may be mounted deployed in a fixed location, and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

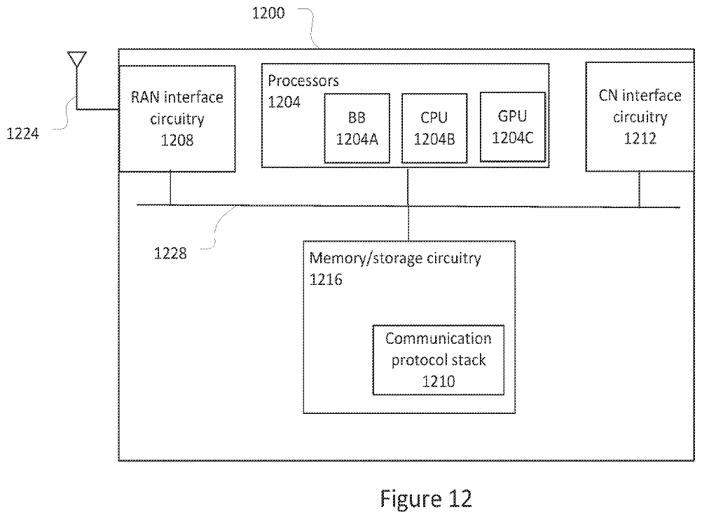

FIG. 12 illustrates a gNB 1200 in accordance with some embodiments. The gNB node 1200 may similar to and substantially interchangeable with gNB 128.

The gNB 1200 may include processors 1204, RF interface circuitry 1208, core network (CN) interface circuitry 1212, and memory/storage circuitry 1216.

The components of the gNB 1200 may be coupled with various other components over one or more interconnects 1228.

The processors 1204, RF interface circuitry 1208, memory/storage circuitry 1216 (including communication protocol stack 1210), antenna 1224, and interconnects 1228 may be similar to like-named elements shown and described with respect to FIG. 11.

The CN interface circuitry 1212 may provide connectivity to a core network, for example, a 5^{th} Generation Core network (5GC) using a 5GC-compatible network interface protocol such as carrier Ethernet protocols, or some other suitable protocol. Network connectivity may be provided to/from the gNB 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method of operating a UE, the method comprising: processing an information element (IE) to determine a plurality of orthogonal frequency division multiplexing (OFDM) symbols for a channel state information-reference signal (CSI-RS) resource; receiving a plurality of CSI-RSs over the plurality of OFDM symbols for the CSI-RS resource; determining a plurality of estimated channels corresponding to each of the plurality of OFDM symbols by applying different sequences from a predetermined matrix; constructing a channel based on the plurality of estimated channels; and determining a receive beam based on the channel and the predetermined matrix.

Example 2 may include the method of example 1 or some other example herein, wherein each CSI-RS of the plurality of CSI-RSs is mapped to a corresponding OFDM symbol using a common resource element mapping pattern.

Example 3 may include the method of example 1 or some other example herein, wherein individual CSI-RSs of the plurality of CSI-RSs are mapped to corresponding OFDM symbols using individual RE mapping patterns.

Example 4 may include the method of example 1 or some other example herein, wherein each CSI-RS of the plurality of CSI-RSs is mapped to a respective physical resource block within a bandwidth part.

Example 5 may include the method of example 4 some other example herein, further comprising: determining, based on a predetermined configuration or a control signal, an offset between adjacent physical resource blocks that include a CSI-RS of the plurality of CSI-RSs.

Example 6 may include the method of example 1 or some other example herein, further comprising: transmitting a report to a base station to indicate a minimal number of symbols per CSI-RS resource, wherein the plurality of OFDM symbols is equal to or greater than the minimal number.

Example 7 may include the method of example 1 or some other example herein, wherein the plurality of CSI-RSs are associated with a resource set configured with repetition.

Example 8 may include a method of operating a UE, the method comprising: receiving an information element (IE) to configure a reference signal (RS) for beam management (BM), the information element to include an indication that the RS for BM is beam associated with a channel-state information-reference signal (CSI-RS) or a synchronization signal block (SSB); receiving the RS for BM and the CSI-RS or SSB over a plurality of OFDM symbols; and determining a receive beam for the antenna panel based on receipt of the RS for BM and the CSI-RS or SSB.

Example 9 may include the method of example 8 or some other example herein, wherein the indication includes a transmission configuration indicator (TCI) state that is to indicate a quasi-co-location relationship between the RS for BM and the CSI-RS or SSB.

Example 10 may include the method of example 9 Or some other example herein, wherein the quasi-co-location relationship indicates a common Doppler shift, Doppler spread, average delay, delay spread, spatial receive parameter, and average gain.

Example 11 may include the method of example 9 or some other example herein, further comprising: assuming, based on the indication, the RS for BM and the CSI-RS or SSB are transmitted from a same antenna port (for example, a same precoder and analog beam); and determining the receive beam based on the assumption the RS for BM and the CSI-RS or SSB are transmitted from the same antenna port.

Example 12 may include the method of example 9 or some other example herein, wherein the indication is to indicate the RS for BM is beam associated with the SSB and the method further comprises: considering the SSB to be three or four CSI-RS resources; and determining the receive beam based on the consideration that the SSB is three or four CSI-RS resources.

Example 13 may include the method of example 12 or some other example herein, further comprising: considering the SSB to be three or four CSI-RS transmissions based on a predefined configuration or a UE capability.

Example 14 may include the method of example 9 or some other example herein, further comprising: transmitting, to a gNB, a report to indicate a time window in which resources, including the RS for BM and the CSI-RS or SSB, can be considered coherent with one another and used for one beam searching operation; and determining the receive beam based on resources within the time window.

Example 15 may include the method of example 9 or some other example herein, wherein the RS for BM is a first SSB and the CSI-RS or SSB includes a second SSB, wherein the first and second SSBs are in a common serving cell or in different serving cells.

Example 16 may include the method of example 9 or some other example herein, wherein the indication is to indicate a first antenna port that is used to transmit the RS for BM is port associated with a second antenna port that is used to transmit the CSI-RS or SSB.

Example 17 may include the method of example 9 or softie other example herein, further comprising: generating a UE capability report, for radio link monitoring (RLM) or beam failure detection (BFD) based on resources that include RS for BM and CSI-RS or SSB being counted as one RLM or BED reference signal.

Example 18 may include the method of example 9 or some other example herein, further comprising: calculating a beamforming weight for the receive beam; calculating a block error ratio (BLER) for a hypothetical physical downlink control channel (PDCCH) transmission based on the beamforming weight; and determining a beam failure instance or in-sync/out-of-sync indication based on the BLER.

Example 19 may include a method of operating a gNB, the method comprising: receiving, from a user equipment (UE), an indication of a number of measurement instances desired for a channel-based beamforming operation; generating configuration information to configure a reference signal for beamforming to be transmitted over a number of orthogonal frequency division multiplexing (OFDM) symbols that corresponds to the number of measurement instances; and transmitting the configuration information to the UE.

Example 20 may include the method of example 19 or some other example herein, wherein the configuration information includes a channel state information-reference signal resource mapping information element that includes an indication of the number of OFDM symbols; or beam association information to indicate that a first reference signal and a second reference signal are to be transmitted by the gNB with a common antenna port (for example, precoder and analog beam).

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to airy of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDC, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 max include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more non-transitory computer-readable media having instructions that, when executed by one or more processors, cause a user equipment (UE) to:
process an information element (IE) to determine a plurality of orthogonal frequency division multiplexing (OFDM) symbols for a channel state information-reference signal (CSI-RS) resource;
receive a plurality of CSI-RSs over the plurality of OFDM symbols for the CSI-RS resource;
determine a plurality of estimated channels corresponding to each of the plurality of OFDM symbols by applying different sequences from a predetermined matrix;
construct a channel based on the plurality of estimated channels; and
determine a receive beam based on the channel and the predetermined matrix.

2. The one or more non-transitory computer-readable media of claim 1, wherein each CSI-RS of the plurality of CSI-RSs is mapped to a corresponding OFDM symbol using a common resource element mapping pattern.

3. The one or more non-transitory computer-readable media of claim 1, wherein individual CSI-RSs of the plurality of CSI-RSs are mapped to corresponding OFDM symbols using individual RE mapping patterns.

4. The one or more non-transitory computer-readable media of claim 1, wherein each CSI-RS of the plurality of CSI-RSs is mapped to a respective physical resource block within a bandwidth part.

5. The one or more non-transitory computer-readable media of claim 4, wherein the instructions, when executed, further cause the UE to: determine, based on a predetermined configuration or a control signal, an offset between adjacent physical resource blocks that include a CSI-RS of the plurality of CSI-RSs.

6. The one or more non-transitory computer-readable media of claim 1, wherein the instructions, when executed, further cause the UE to: transmit a report to a base station to indicate a minimal number of symbols per CSI-RS resource, wherein the plurality of OFDM symbols is equal to or greater than the minimal number.

7. The one or more non-transitory computer-readable media of claim 1, wherein the plurality of CSI-RSs are associated with a resource set configured with repetition.

8. A user equipment (UE) comprising:
an antenna panel; and
processing circuitry coupled with the antenna panel, the processing circuitry to:
receive an information element (IE) to configure a reference signal (RS) for beam management (BM), the information element to include an indication that the RS for BM is beam associated with a channel-state information—reference signal (CSI-RS) or a synchronization signal block (SSB);
receive the RS for BM and the CSI-RS or SSB over a plurality of OFDM symbols; and
determine a receive beam for the antenna panel based on receipt of the RS for BM and the CSI-RS or SSB.

9. The UE of claim 8, wherein the indication includes a transmission configuration indicator (TCI) state that is to indicate a quasi-co-location relationship between the RS for BM and the CSI-RS or SSB.

10. The UE of claim 9, wherein the quasi-co-location relationship indicates a common Doppler shift, Doppler spread, average delay, delay spread, spatial receive parameter, and average gain.

11. The UE of claim 8, wherein the processing circuitry is to: assume, based on the indication, the RS for BM and the CSI-RS or SSB are transmitted from a same antenna port; and determine the receive beam based on the assumption the RS for BM and the CSI-RS or SSB are transmitted from the same antenna port.

12. The UE of claim 8, wherein the indication is to indicate the RS for BM is beam associated with the SSB and the processing circuitry is further to: consider the SSB to be three or four CSI-RS resources; and determine the receive beam based on the consideration that the SSB is three or four CSI-RS resources.

13. The UE of claim 12, wherein the processing circuitry is further to: consider the SSB to be three or four CSI-RS transmissions based on a predefined configuration or a UE capability.

14. The UE of claim 8, wherein the processing circuitry is further to: transmit, to a gNB, a report to indicate a time window in which resources, including the RS for BM and the CSI-RS or SSB, can be considered coherent with one another and used for one beam searching operation; and determine the receive beam based on resources within the time window.

15. The UE of claim 8, wherein the RS for BM is a first SSB and the CSI-RS or SSB includes a second SSB, wherein the first and second SSBs are in a common serving cell or in different serving cells.

16. The UE of claim 8, wherein the indication is to indicate a first antenna port that is used to transmit the RS for BM is port associated with a second antenna port that is used to transmit the CSI-RS or SSB.

17. The UE of claim 8, wherein the processing circuitry is further to: generate a UE capability report for radio link monitoring (RLM) or beam failure detection (BFD) based on resources that include RS for BM and CSI-RS or SSB being counted as one RLM or BFD reference signal.

18. The UE of claim 8, wherein the processing circuitry is further to: calculate a beamforming weight for the receive beam; calculate a block error ratio (BLER) for a hypothetical physical downlink control channel (PDCCH) transmission based on the beamforming weight; and determine a beam failure instance or in-sync/out-of-sync indication based on the BLER.

19. A method of operating a gNB comprising:
receiving, from a user equipment (UE), an indication of a number of measurement instances desired for a channel-based beamforming operation;
generating configuration information to configure a reference signal for beamforming to be transmitted over a number of orthogonal frequency division multiplexing (OFDM) symbols that corresponds to the number of measurement instances; and
transmitting the configuration information to the UE.

20. The method of claim 19, wherein the configuration information includes a channel state information-reference signal resource mapping information element that includes an indication of the number of OFDM symbols; or beam association information to indicate that a first reference signal and a second reference signal are to be transmitted by the gNB with a common antenna port.
